(19) United States
(12) Patent Application Publication
(10) Pub. No.: US 2015/0287410 A1
(43) Pub. Date: Oct. 8, 2015

(54) SPEECH AND SEMANTIC PARSING FOR CONTENT SELECTION

(71) Applicant: Google Inc., Mountain View, CA (US)

(72) Inventors: Pedro J. Moreno Mengibar, Jersey City, NJ (US); Mark Edward Epstein, Katonah, NY (US)

(21) Appl. No.: 13/844,312

(22) Filed: Mar. 15, 2013

(51) Int. Cl. G10L 17/00

(52) U.S. Cl. CPC G10L 17/005

(57) ABSTRACT

Systems, apparatus and method for speech and semantic parsing for content selection. In an aspect, a method includes selecting, for each of a plurality of voice query analyzers, an analyzer output parameter; generating a voice query model for voice queries, the voice query model including analysis fields, wherein each analysis field in at least a first portion of the analysis fields corresponds to a corresponding analyzer output parameter; receiving, from a plurality of content item providers, voice query selection data that describes analyzer output parameter values for the voice query model that satisfy selection criteria for the content item provider; and persisting the voice query selection data for the content item providers to a computer memory device; wherein the voice query analyzers include a semantic analyzer and a biometric analyzer.

### BACKGROUND

This specification relates to speech recognition and speech understanding systems.

Speech recognition and speech processing systems are prevalent in many consumer electronic devices. Many of these electronic devices now utilize speech command processing techniques to invoke and perform particular operations. For example, a user device, such as a smart phone, can process speech commands to perform specified operations that include searching the web, setting an alarm, calling a particular person, and so on.

Furthermore, providing advertisements with resources served over the Internet is now prevalent in the advertising industry. Many advertising selection processes, however, rely on textual content of a query and user profile information to select advertisements for users.

### SUMMARY

In general, one innovative aspect of the subject matter described in this specification can be embodied in methods that include the actions of selecting, for each of a plurality of voice query analyzers, an analyzer output parameter; generating a voice query model for voice queries, the voice query model including analysis fields, wherein each analysis field in at least a first portion of the analysis fields corresponds to a corresponding analyzer output parameter; receiving, from a plurality of content item providers, voice query selection data that describes analyzer output parameter values for the voice query model that satisfy selection criteria for the content item provider; and persisting the voice query selection data for the content item providers to a computer memory device; wherein the voice query analyzers include a semantic analyzer and a biometric analyzer. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. The analysis of voice commands by multiple analyzers allows for the selection of content items according to selection criteria that does not require personalized information. For example, age and gender can be determined form the voice command without accessing personal information of the user. Accordingly, selective advertising can be accomplished without the need to rely on personalized information. Furthermore, because each voice command is processed when received, multiple different users using the same device will receive selective advertisements based on their respectively processed voice commands. Additional information, such as semantic classification of the voice command, environmental data, and client type, also allows for additional selection criteria. As a result, the likelihood of a highly effective advertisement being served increases, as does the advertiser's return on investment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an environment in which voice queries are processed and modeled into voice query models.

FIG. 2 is a system flow diagram of processing and responding to a voice query.

FIG. 3 is a process flow diagram of an example process for voice query modeling and content selection based on voice query model data.

FIG. 4 is an illustration of a user interface for specifying voice query model parameter values to select content in response to voice queries.

FIG. 5 is a block diagram of an example data processing apparatus.

FIG. 6 is a block diagram of an example mobile computing device.

Like reference numbers and designations in the various drawings indicate like elements.

### DETAILED DESCRIPTION

Typed queries tend to be very terse and directed to specific subject matter that will satisfy a user's information need, e.g., “French restaurants.” Users, however, often provide voice queries that are much more verbose than a typed query. For example, instead of simply saying “French restaurant,” a user might say “please find French restaurants close to me.”

The systems and methods of this specification allow for the other information to be extracted by use of corresponding voice and audio analyzers that are designed to identify and classify certain audio features, and facilitates content selection (such as advertisement content) based on the extracted information. Furthermore, audio data that is captured for a voice query not only specifies the actual textual information (the audio is transformed to text via a speech recognition system) but also other types of information, such as gender, sentiment (e.g., emotional state), background/environmental noise, age range, and so on. The systems and methods of this specification also allow for selection of advertisements based on this information.

The system utilizes a set of voice analyzers to analyze voice queries. A voice query model that includes analysis fields that correspond to the outputs of the voice analyzers is used to model voice queries analyzed by the voice analyzers. The data that are captured, however, are not tethered to the identity of a particular person, and thus user privacy is protected. Content item providers, such as advertisers, provide voice query selection data that describes analyzer output parameter values for the voice query model that satisfy selection criteria for the advertiser. In response to a voice query, the system selects an advertisement represented by a voice query model having analyzer output parameter values that satisfy the selection criteria for the advertiser.

Operation of the system, the modeling of voice queries, and the selection of content based on modeled voice queries and selection criteria are described in more detail below.

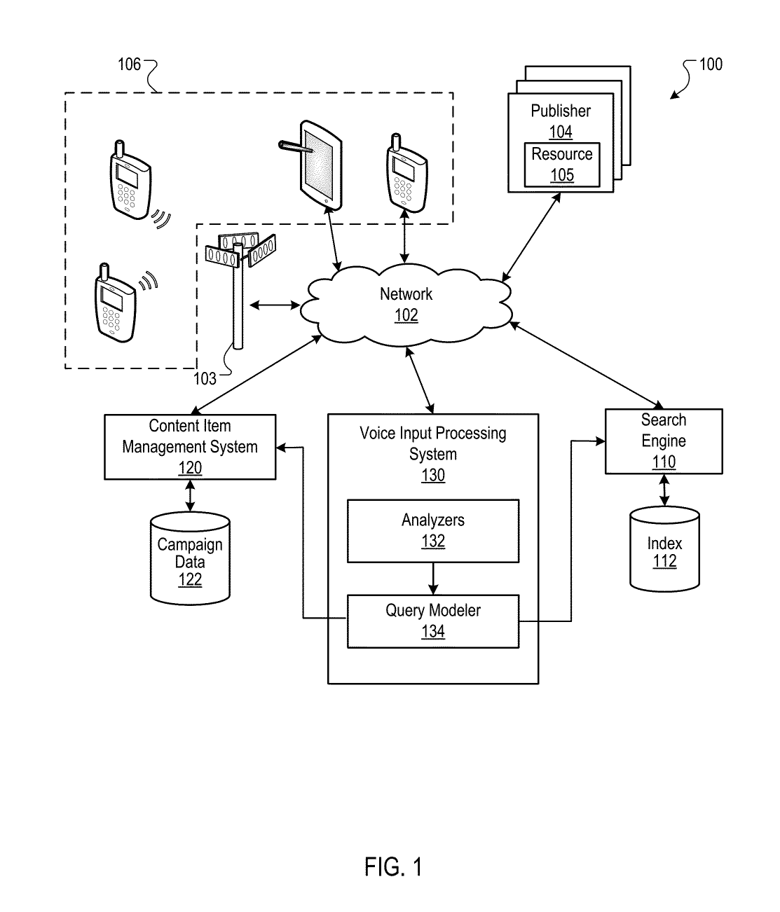

FIG. 1 is a block diagram of an environment 100 in which voice queries are processed and modeled into voice query models. A computer network 102, such as a local area network (LAN), wide area network (WAN), the Internet, or a combination thereof, provides for data communication between electronic devices and systems. Examples of such electronic device and system include publisher web sites 104 and user devices 106. The computer network 102 may also be included, or be in data communication with, one or more wireless networks 103.

A publisher website 104 includes one or more resources 105 associated with a domain name and hosted by one or more servers. An example website is a collection of web pages formatted in hypertext markup language (HTML) that can contain text, images, multimedia content, and programming elements, such as scripts. Each publisher website 104 is maintained by a content publisher, which is an entity that controls, manages and/or owns the website 104. A resource 105 is any data that can be provided by the publisher web site 104 over the network 102 and that is associated with a resource address.

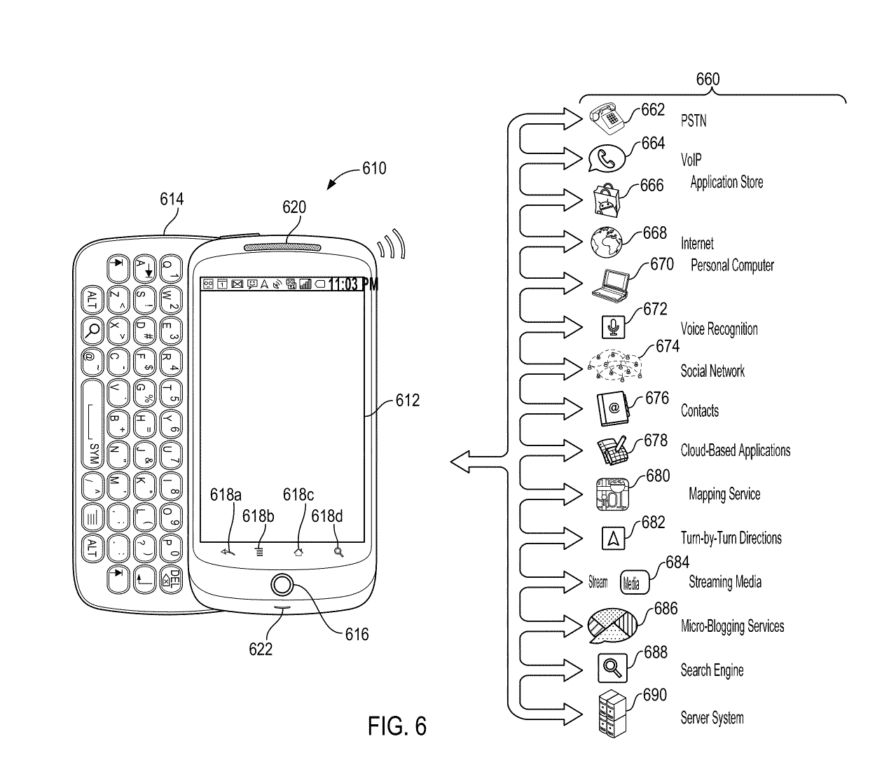

A user device 106 is an electronic device that is under the control of a user and is capable of requesting and receiving resources over the network 102, establishing communication channels, e.g., voice communications, with other user devices 106, and also capable of performing other actions. Example user devices 106 include personal computers, mobile communication devices, and other devices that can send and receive data over the network 102. An example mobile user device 106, such as a smart phone, is described with reference to FIG. 6 below. The user devices 106 may communicate over the networks 102 and 103 by means of wired and wireless connections with the networks 102 and 103.

To facilitate searching of these resources 105, the search engine 110 identifies the resources by crawling the publisher web sites 104 and indexing the resources provided by the publisher web sites 104. The resources are indexed and the index data are stored in an index 112.

As will be described in more detail below, the user devices 106 submit queries to the search engine 110. In response to the queries, the search engine 110 uses the index 112 to identify resources that are relevant to the queries. The search engine 110 identifies the resources in the form of search results and returns the search results to the user devices 106 in search results page resource. A search result for a resource can include a web page title, a snippet of text extracted from the web page, and a resource locator for the resource, e.g., the URL of a web page. The search results are ordered according to search scores and provided to the user device according to the order.

The content item management system 120 provides content items for presentation with the resources 105 and search results. A variety of appropriate content items can be provided. One example content item is an advertisement. In the case of advertisements, the content item management system 120 allows advertisers to define selection rules that take into account attributes of the particular user to provide relevant advertisements for the users. Example selection criteria are described in more detail below. Advertisements for which the selection criteria are met and having bids that result in an advertisement slot being awarded in response to an auction are selected for displaying in the advertisement slots. The content item management system 120 includes a data storage system that stores campaign data 122. The campaign data 122 stores the advertisements, the selection information, and the budgeting information for advertisers.

When a user of a user device 106 selects an advertisement, the user device 106 generates a request for a landing page of the advertisement, which is typically a web page of the advertiser. The relevant advertisements can be provided for presentation on the resources 105 of the publishers 104, or on a search results page resource. For example, a resource 105 from a publisher 104 may include instructions that cause a user device to request advertisements from the content item management system 120. The request includes a publisher identifier and, optionally, keyword identifiers related to the content of the resource 105. The content item management system 120, in turn, provides advertisements to the requesting user device. With respect to a search results page, the user device renders the search results page and sends a request to the content item management system 120, along with one or more keywords related to the query that the user provide to the search engine 110. The content item management system 120, in turn, provides advertisements to the requesting user device.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

As described above, many of the user devices 106 utilize voice processing software that facilitates the submission of queries in the form of voice inputs. The user device 106 may provide the voice query recording as the voice query input to the search engine 110. Thus, in some implementations, the search engine 110 and the content item management system 120 may be in data communication with a voice input processing system 130 that processes a voice query input and generates a set of parameter values that describes features of the voice query. The voice input processing system 130 includes a set of analyzers 132 that each generates data that describe features the respective analyzer is configured to identify and/or quantify. These data are provided to a query modeler 134 that generates data describing the analyzed voice query. The data are then provided to the search engine 110 and the content item management system 130 to identify resources responsive to the query and content items that are also responsive to the query.

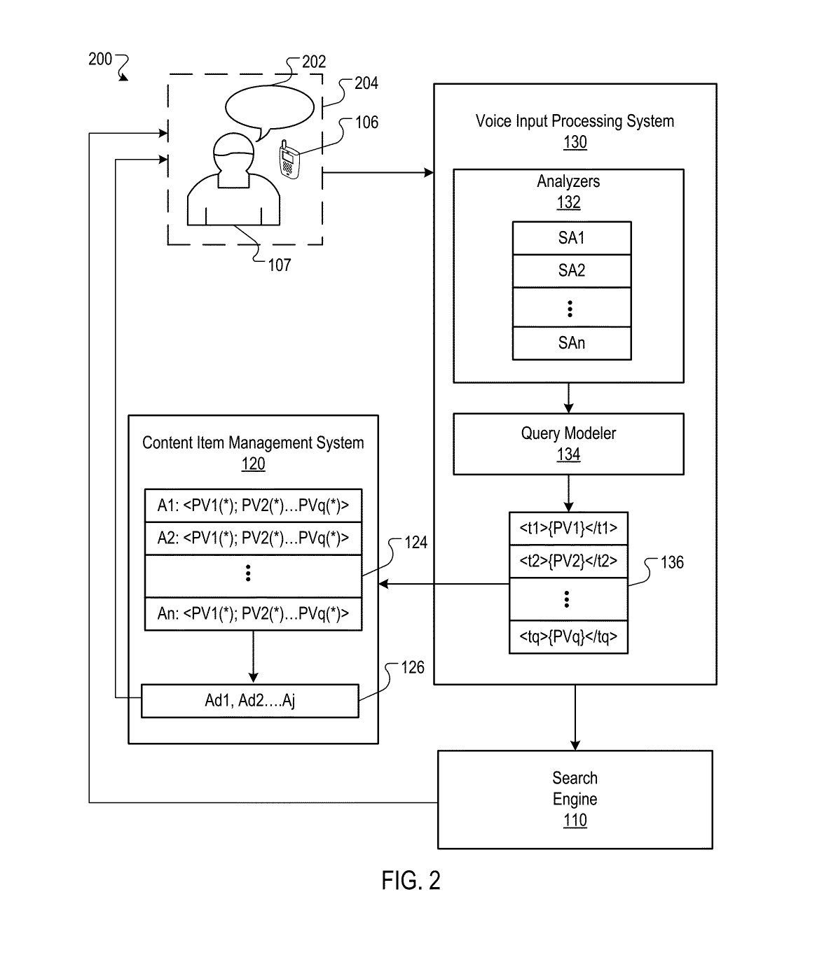

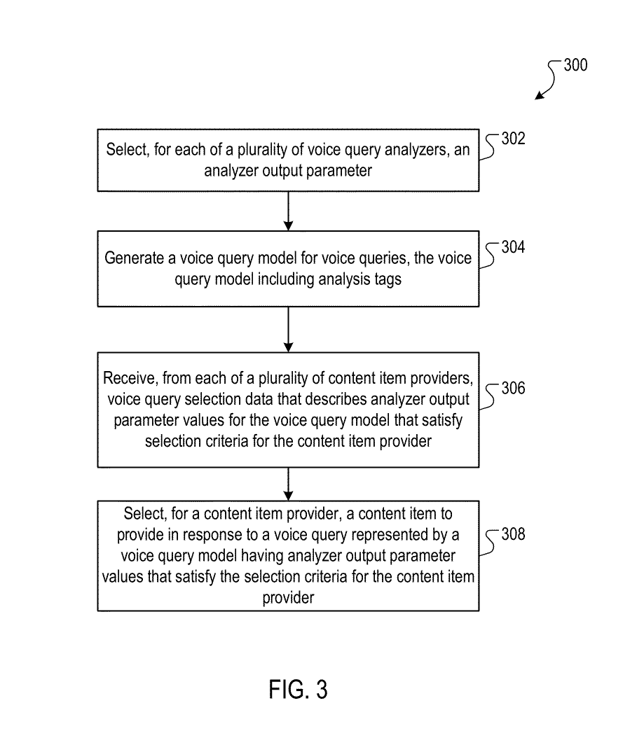

Operation of the voice input processing system 130 is described in more detail with respect to FIG. 2, which is a system flow diagram 200 of processing and responding to a voice query, and FIG. 3, which is a process flow diagram 300 of an example process for voice query modeling and content selection based on voice query model data.

Although the voice input processing system 130 is depicted as being a system that receives a voice query from a user device 106 and processes the voice query, the voice input processing system 130 can also be implemented in a user device and provide a query model populated with parameter values for a voice query to the search engine 110 and other systems external to the user device 106. Alternatively, the user device 106 may implement only the analyzers and provide the analyzer outputs to a query modeler 134 that is operating on a system external to the user device 106, such as the search engine 110 and/or the content item management system 120. Alternatively, the voice input processing system 130 can be completely implemented as a subsystem component of the search engine 110, and/or the content item management system 120.

The voice input processing system 130 includes multiple analyzers 132, denoted as SA1, SA2 . . . SAn. A variety of appropriate audio analyzers can be used. In some implementations, the analyzers include a speech to text analyzer, a semantic analyzer, biometric analyzers, and environmental analyzers. The speech to text analyzer generates text output that is a transcription of the voice input.

The semantic analyzer analyzes the voice query input and generates output parameter values that describe the semantic meaning of the voice query. For example, if the voice query is “Find me a pair of running shoes that are less than 150 dollars,” the semantic analyzer may output parameters values of “Shopping” and “price range less than 150 dollars.”

The biometric analyzers may output a variety of biometric feature values, depending on the analyzers used. For example, one biometric analyzer can be a gender analyzer to output a gender value that describes the gender of the speaker. Another biometric analyzer can be an age analyzer that describes an age range in which the speaker's age is determined to belong. Yet another biometric analyzer is sentiment detection/analyzer that detects one or more sentiments (e.g., emotional states) of the speaker of the voice query and outputs an emotion parameter value that describes the determined sentiment. Other biometric features can also be determined by use of other biometric analyzers.

Environmental analyzers output environmental feature values that describe an environment in which the speaker of the voice query is present. For example, one environmental analyzer may be configured to determine whether the speaker is alone or in the presence of other people by identifying different voice signatures in the voice query. Another environmental analyzer may be configured to determine whether the speaker is in a quiet or loud environment by processing background noise. Still another environmental analyzer may be configured to determine whether a speaker is in an automobile. Other environmental features can also be determined by use of other environmental analyzers.

In operation, the system 130 selects, for each of the voice query analyzers, an analyzer output parameter (302). For example, for a biometric analyzer that outputs a gender type parameter, the gender type parameter is selected; for an analyzer that outputs an age range, an age range parameter is selected. For a speech to text analyzer, the text output of the analyzer is selected, and so on.

The system 130 generates a voice query model for voice queries that include analysis fields. Each analysis field corresponds to a selected analyzer output parameter. For example, assume the analyzers include a speech to text analyzer, a gender analyzer, an age range analyzer, and sentiment analyzer. The query model may be of the form:

<Query>
<Query_Text>{ }</Query_Text>
<Gender>{ }</Gender>
<Age_Range>{ }</Age_Range>
<Emotion>{ }</Emotion>
</Query>

In some implementations, only a first portion of the analysis fields each correspond to a corresponding analyzer output parameter. Other portions may be derived from the parameter values of the first portion of the analysis fields, or may be derived from other data, such as geo data, client type, etc. For example, the query model above may include a geo tag and a price range:

<Query>
<Query_Text>{ }</Query_Text>
<Gender>{ }</Gender>
<Age_Range>{ }</Age_Range>
<Emotion>{ }</Emotion>
<Geo>{ }</Geo>
<Price>{ }</Price>
</Query>

The geo tag parameter value may be derived from GPS data provided with the voice query, and the price range may be derived from the text of the voice query.

The content item management system 120 receives, from each of a plurality of content item providers, voice query selection data that describes analyzer output parameter values for the voice query model that satisfy selection criteria for the content item provider (306). The voice query selection data are used to select content items in response to voice queries. For example, once a voice query model is determined, the voice query model fields can be provided to advertisers so that advertisers may define selection criteria for serving advertisements in response to voice queries.

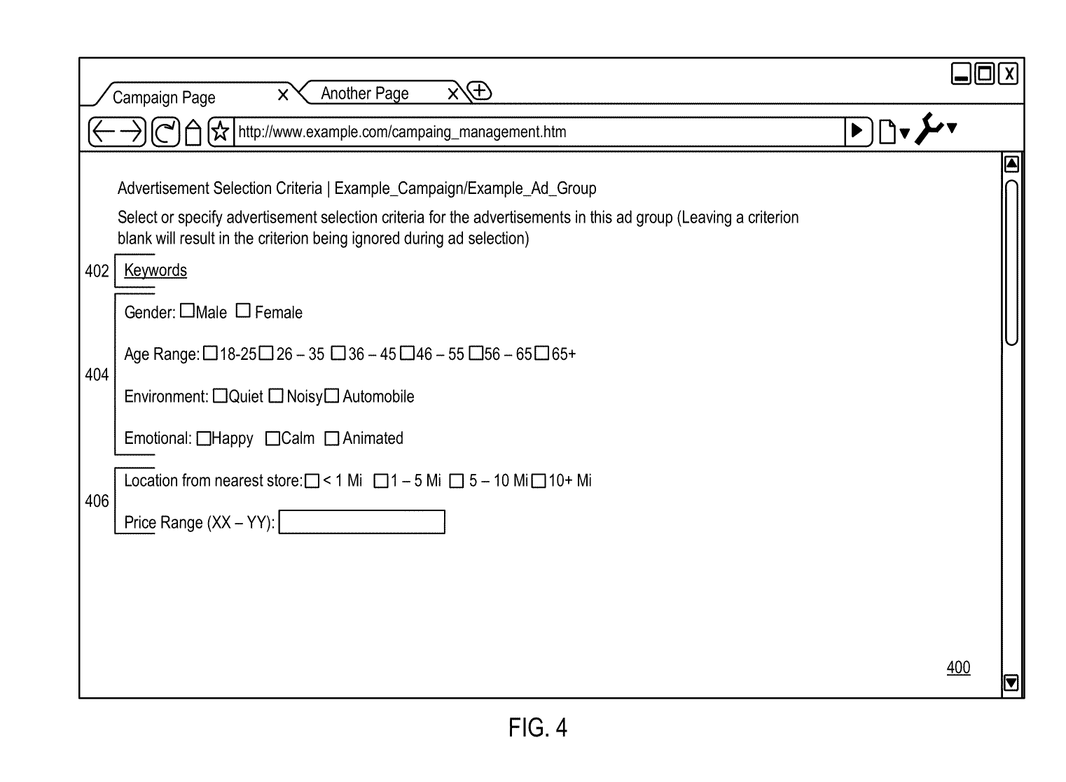

FIG. 4 is an illustration of a user interface 400 for specifying voice query model parameter values to select content in response to voice queries. The user interface 400 includes a keyword link 402, biometric and environmental parameter selection fields 404, and derived fields 406. Selection of the keyword link 402 takes the user to a keyword selection user interface that the advertiser may use to determine relevant keywords used to select an advertisement.

Selection of the various biometric and environmental parameter fields 404 determines which parameter values meet selection criteria for the advertisement or ad group. For example, if the advertiser desires that advertisements for the ad group be provided to males from the age of 26-45 only in quiet environments and only when in a calm emotional state, the follow check boxes would be selected: Male; 26-35 and 36-45; Quiet; and Calm. The advertiser may also select location preferences and a price range as additional selection criteria.

The derived fields 406 described features that are derived from the outputs of the analyzers 132 and other data, such as geo data. For example, if the advertiser desires that advertisements for the ad group be selected for when a potential customer is within five miles of the store, and for a price range of $100 or less, the advertiser would select the “<1 Mi” and the “1-5 Mi” check boxes, and input a price range of “0-100.”

The resulting selections are stored in query model selection data 124 in the content item management system 120. As shown in FIG. 2, advertisers A1 . . . An each have corresponding query model selection data <PV1(*); PV2(*) . . . PVq(*)> . . . <PV1(*); PV2(*) . . . PVq(*)>, where PVj corresponds to a specified parameter value for a j^{th} query model field. For example, for the example above, the query model selection data for advertiser A1 would be of the form:

A1:<[Keywords];
Gender(Male);
Age(26-35; 36-45);
Environment(Quiet);
Emotional(Calm);
Location(<1; 1-5);
Price Range(0-100);>

The content item management system 110 selects, for a content item provider, a content item to provide in response to a voice query represented by a voice query model having analyzer output parameter values that satisfy the selection criteria for the content item provider (308). For example, the analyzers 132 output the parameter values of a received voice query 202 spoken by a user. The user is in an environment 204. The various speech to text analyzers, biometric analyzers, and environmental analyzers generate corresponding parameter values that are used to populate various parameter fields of a query model. The populated query model 136 for a particular voice query 202 depicts the output of the query modeler 134. For example, assume the user 107 is a 38 year old male and inputs the voice query “Find an inexpensive digital camera within three miles of me.” Also assume the user 107 is speaking in a quiet environment and in a calm voice. The populated query model 136 may be:

<Keyword(digital camera);
Gender(Male);
Age(36-45);
Environment(Quiet);
Emotional(Calm);
Location(<=3);
Price Range(0-100);>

Provided the query model selection data 124 specified by the advertiser as described above includes the keyword “digital camera”, the advertisement management system would determine that the populated query model 136 for the voice query 202 matches the query model selection data 124 for advertiser A1. In response, an advertisement would be selected to be provided to the user 107, or, alternatively, would be eligible to participate in an auction.

Depending on the number analyzers used, a processed voice query may result in a highly analyzed format. For example, assume a user is driving a car and inputs the following voice query “Find me a cheap pair of Brand X shoes nearby.” The following query model populated with parameter values could be:

<TEXT> find me a cheap pair of Brand X shoes nearby </TEXT>
<MODE>car</MODE>
<GENDER> female</GENDER>
<AGE>30-40</AGE>
<EMOTION>happy</EMOTION>
<SPEAKERID>phone user</SPEAKERID>
<SEMANTIC_TAG>shopping</SEMANTIC_TAG>
<PRODUCT>shoes</PRODUCT>
<BRAND>Brand X</BRAND>
<GEO>LAT/LONG</GEO>
<GEO_RANGE>1km</GEO_RANGE>
<START_PRICE>0$</START_PRICE>
<END_PRICE>75$</END_PRICE>

The query modeler 134 derives the Product and Brand parameter values are derived from the text of the voice query. The LAT/LONG is representative of the latitude and longitude values that describe the GPS coordinates of the mobile device as detected by a GPS device within the mobile device. The MODE is detected by the relative speed of the user device and its position as determined by GPS readings. The Geo Range is derived from a mapping of ranges for various query constraints. For example, for a “car” mode, “nearby” and other synonymous location terms may map to 1 kilometers or less; for an “on foot” mode, “nearby” and other synonymous location terms may map to 0.5 kilometers or less, etc. Likewise, the start and end prices may be determined from mappings of pricing terms, such as “cheap” for the lowest range; “mid-range” for mid-range prices; and “expensive” for the highest range of prices.

In some implementations, selection data for advertisers may be based on a semantic type that is determined for a query. For example, different query types may have different selection data by which an advertiser could specify selection criteria. To illustrate, assume that a content item management system 120 has the follow selection criteria available for each semantic type:

| Semantic Type | PARAM1 | PARAM2 | PARAM3 | PARAM4 | PARAM5 |
|---|---|---|---|---|---|
| Air Travel | <ORIGIN> | <DEST> | <START_TIME> | <END_TIME> | <FARE_CLASS> |
| Shopping | <BUSINESS> | <PRODUCT> | <MIN_PRICE> | <MAX_PRICE> | <AGE> |
| Banking | <CUSTOMER> | <ACCOUNT_TYPE> | <TRANSACTION> | | |

Advertisers may bid for each of semantic types of voice queries. The bids may be expanded based on additional information, such as environment, emotion, and the like.

In situations in which the systems discussed here collect personal information about users, or may make use of personal information, the users may be provided with an opportunity to control whether programs or features collect user information or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

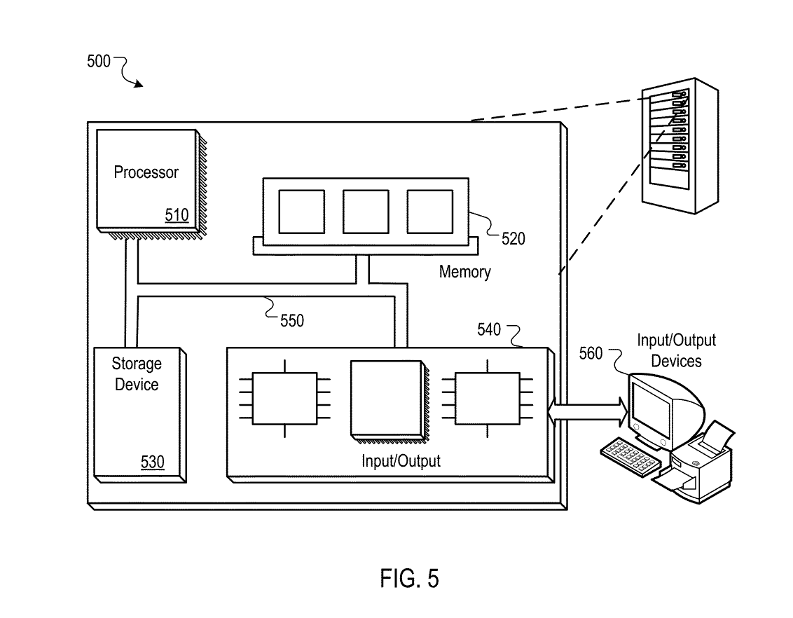

FIG. 5 is block diagram of an example computer system 500 that can be used to implement a data processing apparatus. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

FIG. 6 is a block diagram of example mobile computing device. In this illustration, the mobile computing device 610 is depicted as a handheld mobile telephone (e.g., a smartphone, or an application telephone) that includes a touchscreen display device 612 for presenting content to a user of the mobile computing device 610 and receiving touch-based user inputs. Other visual, tactile, and auditory output components may also be provided (e.g., LED lights, a vibrating mechanism for tactile output, or a speaker for providing tonal, voice-generated, or recorded output), as may various different input components (e.g., keyboard 614, physical buttons, trackballs, accelerometers, gyroscopes, and magnetometers).

Example visual output mechanism in the form of display device 612 may take the form of a display with resistive or capacitive touch capabilities. The display device may be for displaying video, graphics, images, and text, and for coordinating user touch input locations with the location of displayed information so that the device 610 can associate user contact at a location of a displayed item with the item. The mobile computing device 610 may also take alternative forms, including as a laptop computer, a tablet or slate computer, a personal digital assistant, an embedded system (e.g., a car navigation system), a desktop personal computer, or a computerized workstation.

An example mechanism for receiving user-input includes keyboard 614, which may be a full qwerty keyboard or a traditional keypad that includes keys for the digits ‘0-9’, ‘*’, and ‘#.’ The keyboard 614 receives input when a user physically contacts or depresses a keyboard key. User manipulation of a trackball 616 or interaction with a track pad enables the user to supply directional and rate of movement information to the mobile computing device 610 (e.g., to manipulate a position of a cursor on the display device 612).

The mobile computing device 610 may be able to determine a position of physical contact with the touchscreen display device 612 (e.g., a position of contact by a finger or a stylus). Using the touchscreen 612, various “virtual” input mechanisms may be produced, where a user interacts with a graphical user interface element depicted on the touchscreen 612 by contacting the graphical user interface element. An example of a “virtual” input mechanism is a “software keyboard,” where a keyboard is displayed on the touchscreen and a user selects keys by pressing a region of the touchscreen 612 that corresponds to each key.

The mobile computing device 610 may include mechanical or touch sensitive buttons 618a-d. Additionally, the mobile computing device may include buttons for adjusting volume output by the one or more speakers 620, and a button for turning the mobile computing device on or off. A microphone 622 allows the mobile computing device 610 to convert audible sounds into an electrical signal that may be digitally encoded and stored in computer-readable memory, or transmitted to another computing device. The mobile computing device 610 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. The operating system may provide a platform for the execution of application programs that facilitate interaction between the computing device and a user.

The mobile computing device 610 may present a graphical user interface with the touchscreen 612. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 604. User-selection of the button may invoke the pre-defined action.

The mobile computing device 610 may include other applications, computing sub-systems, and hardware. A voice recognition service 672 may receive voice communication data received by the mobile computing device's microphone 622, and translate the voice communication into corresponding textual data or perform voice recognition.

A call handling unit may receive an indication of an incoming telephone call and provide a user the capability to answer the incoming telephone call. A media player may allow a user to listen to music or play movies that are stored in local memory of the mobile computing device 610. The mobile device 610 may include a digital camera sensor, and corresponding image and video capture and editing software. An internet browser may enable the user to view content from a web page by typing in an addresses corresponding to the web page or selecting a link to the web page.

A service provider that operates the network of base stations may connect the mobile computing device 610 to the network 650 to enable communication between the mobile computing device 610 and other computing systems that provide services 660. Although the services 660 may be provided over different networks (e.g., the service provider's internal network, the Public Switched Telephone Network, and the Internet), network 650 is illustrated as a single network. The service provider may operate a server system 652 that routes information packets and voice data between the mobile computing device 610 and computing systems associated with the services 660.

The network 650 may connect the mobile computing device 610 to the Public Switched Telephone Network (PSTN) 662 in order to establish voice or fax communication between the mobile computing device 610 and another computing device. For example, the service provider server system 652 may receive an indication from the PSTN 662 of an incoming call for the mobile computing device 610. Conversely, the mobile computing device 610 may send a communication to the service provider server system 652 initiating a telephone call using a telephone number that is associated with a device accessible through the PSTN 662.

The network 650 may connect the mobile computing device 610 with a Voice over Internet Protocol (VoIP) service 664 that routes voice communications over an IP network, as opposed to the PSTN. For example, a user of the mobile computing device 610 may invoke a VoIP application and initiate a call using the program. The service provider server system 652 may forward voice data from the call to a VoIP service, which may route the call over the internet to a corresponding computing device, potentially using the PSTN for a final leg of the connection.

An application store 666 may provide a user of the mobile computing device 610 the ability to browse a list of remotely stored application programs that the user may download over the network 650 and install on the mobile computing device 610. The application store 666 may serve as a repository of applications developed by third-party application developers. An application program that is installed on the mobile computing device 610 may be able to communicate over the network 650 with server systems that are designated for the application program. For example, a VoIP application program may be downloaded from the Application Store 666, enabling the user to communicate with the VoIP service 664.

The mobile computing device 610 may access content on the internet 668 through network 650. For example, a user of the mobile computing device 610 may invoke a web browser application that requests data from remote computing devices that are accessible at designated universal resource locations. In various examples, some of the services 660 are accessible over the internet.

The mobile computing device may communicate with a personal computer 670. For example, the personal computer 670 may be the home computer for a user of the mobile computing device 610. Thus, the user may be able to stream media from his personal computer 670. The user may also view the file structure of his personal computer 670, and transmit selected documents between the computerized devices.

The mobile computing device 610 may communicate with a social network 674. The social network may include numerous members, some of which have agreed to be related as acquaintances. Application programs on the mobile computing device 610 may access the social network 674 to retrieve information based on the acquaintances of the user of the mobile computing device. For example, an “address book” application program may retrieve telephone numbers for the user's acquaintances. In various examples, content may be delivered to the mobile computing device 610 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 610 may access a personal set of contacts 676 through network 650. Each contact may identify an individual and include information about that individual (e.g., a phone number, an email address, and a birthday). Because the set of contacts is hosted remotely to the mobile computing device 610, the user may access and maintain the contacts 676 across several devices as a common set of contacts.

The mobile computing device 610 may access cloud-based application programs 678. Cloud-computing provides application programs (e.g., a word processor or an email program) that are hosted remotely from the mobile computing device 610, and may be accessed by the device 610 using a web browser or a dedicated program.

Mapping service 680 can provide the mobile computing device 610 with street maps, route planning information, and satellite images. The mapping service 680 may also receive queries and return location-specific results. For example, the mobile computing device 610 may send an estimated location of the mobile computing device and a user-entered query for “pizza places” to the mapping service 680. The mapping service 680 may return a street map with “markers” superimposed on the map that identify geographical locations of nearby “pizza places.”

Turn-by-turn service 682 may provide the mobile computing device 610 with turn-by-turn directions to a user-supplied destination. For example, the turn-by-turn service 682 may stream to device 610 a street-level view of an estimated location of the device, along with data for providing audio commands and superimposing arrows that direct a user of the device 610 to the destination.

Various forms of streaming media 684 may be requested by the mobile computing device 610. For example, computing device 610 may request a stream for a pre-recorded video file, a live television program, or a live radio program.

A micro-blogging service 686 may receive from the mobile computing device 610 a user-input post that does not identify recipients of the post. The micro-blogging service 686 may disseminate the post to other members of the micro-blogging service 686 that agreed to subscribe to the user.

A search engine 688 may receive user-entered textual or verbal queries from the mobile computing device 610, determine a set of internet-accessible documents that are responsive to the query, and provide to the device 610 information to display a list of search results for the responsive documents. In examples where a verbal query is received, the voice recognition service 672 may translate the received audio into a textual query that is sent to the search engine.

These and other services may be implemented in a server system 690. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by a data processing apparatus, comprising:
selecting, for each of a plurality of voice query analyzers, an analyzer output parameter;
providing, to a plurality of computer devices of content item providers, instructions that cause each computer device to display a user interface through which a content item provider specifies analyzer output parameter values for each selected analyzer output parameter;
generating a voice query model for voice queries, the voice query model including analysis fields, wherein each analysis field in at least a first portion of the analysis fields corresponds to a corresponding analyzer output parameter and has a corresponding plurality of selectable analyzer output parameter values displayed in the user interface;
receiving, from each content item provider of the plurality of content item providers, voice query selection data that describes analyzer output parameter values for the voice query model that satisfy selection criteria for the content item provider; and
storing the voice query selection data for the content item providers to a computer memory device as query model selection data in a content item management system;
wherein the voice query analyzers include a semantic analyzer and a biometric analyzer, and the analysis fields of the user interface include analyzer output parameter values for both the semantic analyzer and the biometric analyzer;
receiving a voice query from a user device;
processing the voice query using the voice query analyzers to generate analyzer output parameter values for the voice query and generation a populated voice query mode having the generated analyzer output parameter values; and
selecting, for a content item provider, a content item to provide in response to a voice query represented by a populated voice query that satisfies the selection criteria for the content item provider;
wherein the content item providers are advertisers and the content items are advertisements.

2. (canceled)

3. The computer-implemented method of claim 1, further comprising processing a received voice query by the voice query analyzers and generating the populated voice query model having analyzer the output parameter values of the voice query analyzers.

4. The computer-implemented method of claim 1, wherein the biometric analyzer outputs gender parameter values that identify a gender of the speaker of the voice query.

5. The computer-implemented method of claim 1, wherein the biometric analyzer outputs emotion parameter values that identify sentiment of the speaker of the voice query.

6. The computer-implemented method of claim 1, wherein the biometric analyzer outputs an age parameter value that identifies an age range of the speaker of the voice query.

7. The computer-implemented method of claim 1, wherein the voice query analyzers include an environment analyzer that identifies an environment in which the speaker of the voice query is present.

8. The computer-implemented method of claim 1, wherein:
the voice query model includes a second portion of analysis fields that each correspond to second parameter values determined from output analyzer parameter values to which the first portion of analysis fields correspond;
receiving voice query selection data comprises receiving voice query selection data that describes second parameter values for the voice query model that satisfy selection criteria for the content item provider.

9. The computer-implemented method of claim 8, wherein analyzers include a speech to text analyzer and the second parameter values include a price range parameter value, and further comprising determining a price range from output parameter values of the speech to text analyzer.

10. (canceled)

11. A non-transitory computer readable storage medium storing instructions executable by a data processing apparatus and upon such execution cause the data processing to perform operations comprising:
selecting, for each of a plurality of voice query analyzers, an analyzer output parameter;
providing, to a plurality of computer devices of content item providers, instructions that cause each computer device to display a user interface through which a content item provider specifies analyzer output parameter values for each selected analyzer output parameter;
generating a voice query model for voice queries, the voice query model including analysis fields, wherein each analysis field in at least a first portion of the analysis fields corresponds to a corresponding analyzer output parameter and has a corresponding plurality of selectable analyzer output parameter values displayed in the user interface;
receiving, from each content item provider of the plurality of content item providers, voice query selection data that describes analyzer output parameter values for the voice query model that satisfy selection criteria for the content item provider; and
storing the voice query selection data for the content item providers to a computer memory device as query model selection data in a content item management system;
wherein the voice query analyzers include a semantic analyzer and a biometric analyzer, and the analysis fields of the user interface include analyzer output parameter values for both the semantic analyzer and the biometric analyzer;
receiving a voice query from a user device;
processing the voice query using the voice query analyzers to generate analyzer output parameter values for the voice query and generation a populated voice query mode having the generated analyzer output parameter values; and
selecting, for a content item provider, a content item to provide in response to a voice query represented by a populated voice query that satisfies the selection criteria for the content item provider;
wherein the content item providers are advertisers and the content items are advertisements.

12. (canceled)

13. The computer readable storage medium of claim 11, wherein the operations further comprise processing a received voice query by the voice query analyzers and generating the populated voice query model having analyzer the output parameter values of the voice query analyzers.

14. The computer readable storage medium of claim 11, wherein the biometric analyzer outputs gender parameter values that identify a gender of the speaker of the voice query.

15. The computer readable storage medium of claim 11, wherein the biometric analyzer outputs emotion parameter values that identify sentiment of the speaker of the voice query.

16. The computer readable storage medium of claim 11, wherein the biometric analyzer outputs an age parameter value that identifies an age range of the speaker of the voice query.

17. The computer readable storage medium of claim 11, wherein the voice query analyzers include an environment analyzer that identifies an environment in which the speaker of the voice query is present.

18. The computer readable storage medium of claim 11, wherein:
the voice query model includes a second portion of analysis fields that each correspond to second parameter values determined from output analyzer parameter values to which the first portion of analysis fields correspond;
receiving voice query selection data comprises receiving voice query selection data that describes second parameter values for the voice query model that satisfy selection criteria for the content item provider.

19. The computer-implemented method of claim 18, wherein analyzers include a speech to text analyzer and the second parameter values include a price range parameter value, and further comprising determining a price range from output parameter values of the speech to text analyzer.

20. A system, comprising:
a data processing apparatus; and
a computer readable storage medium in data communication with the data processing apparatus and storing instructions executable by the data processing apparatus and upon such execution cause the data processing to perform operations comprising:
selecting, for each of a plurality of voice query analyzers, an analyzer output parameter;
providing, to a plurality of computer devices of content item providers, instructions that cause each computer device to display a user interface through which a content item provider specifies analyzer output parameter values for each selected analyzer output parameter;
generating a voice query model for voice queries, the voice query model including analysis fields, wherein each analysis field in at least a first portion of the analysis fields corresponds to a corresponding analyzer output parameter and has a corresponding plurality of selectable analyzer output parameter values displayed in the user interface;
receiving, from each content item provider of the plurality of content item providers, voice query selection data that describes analyzer output parameter values for the voice query model that satisfy selection criteria for the content item provider; and
storing the voice query selection data for the content item providers to a computer memory device as query model selection data in a content item management system;
wherein the voice query analyzers include a semantic analyzer and a biometric analyzer, and the analysis fields of the user interface include analyzer output parameter values for both the semantic analyzer and the biometric analyzer;
receiving a voice query from a user device;
processing the voice query using the voice query analyzers to generate analyzer output parameter values for the voice query and generation a populated voice query mode having the generated analyzer output parameter values; and
selecting, for a content item provider, a content item to provide in response to a voice query represented by a populated voice query that satisfies the selection criteria for the content item provider;
wherein the content item providers are advertisers and the content items are advertisements.
